(19) United States
(12) Patent Application Publication
(10) Pub. No.: US 2021/0031444 A1
(43) Pub. Date: Feb. 4, 2021

(54) PLASTICIZATION DEVICE AND THREE-DIMENSIONAL SHAPING DEVICE

(71) Applicant: SEIKO EPSON CORPORATION, Tokyo (JP)

(72) Inventor: Seiichiro YAMASHITA, Azumino-shi (JP)

(21) Appl. No.: 16/943,550

(22) Filed: Jul. 30, 2020

(30) Foreign Application Priority Data
Aug. 1, 2019 (JP) 2019-142059

(51) Int. Cl. B29C 64/153; B29C 64/295; B29C 64/209; B29C 64/241

(52) U.S. Cl. CPC B29C 64/153; B29C 64/295; B33Y 30/00; B29C 64/241; B29C 64/209

(57) ABSTRACT

A plasticization device used in a three-dimensional shaping device includes: a cylinder having a supply port through which a material is supplied; a spiral screw configured to rotate inside the cylinder; a first heating unit provided on an outer peripheral portion of the cylinder; and a nozzle provided on the cylinder and configured to discharge the material plasticized by rotation of the screw and heating of the first heating unit. The outer peripheral portion has, between the supply port and the nozzle, a first region and a second region from the supply port toward the nozzle, and the first heating unit is provided to make a temperature of the second region higher than a temperature of the first region.

The present application is based on, and claims priority from JP Application Serial Number 2019-142059, filed Aug. 1, 2019, the disclosure of which is hereby incorporated by reference herein in its entirety.

### BACKGROUND

### 1. Technical Field

The present disclosure relates to a plasticization device and a three-dimensional shaping device.

### 2. Related Art

For example, in a three-dimensional printer described in WO 2015/129733, a pellet-shaped resin material supplied from a hopper into a cylinder is melted while being conveyed inside the cylinder toward a nozzle by rotation of a screw and heating from a heater, and is then discharged from a tip end of the nozzle.

In the device described above, when a temperature in a vicinity of an inlet of the material in the cylinder becomes too high, the material melts in the vicinity of the inlet, making it difficult to convey the material by the rotation of the screw. Therefore, an amount of the material discharged from the tip end of the nozzle may be insufficient.

### SUMMARY

According to one aspect of the present disclosure, a plasticization device used in a three-dimensional shaping device is provided. The plasticization device includes: a cylinder having a supply port through which a material is supplied; a spiral screw configured to rotate inside the cylinder; a first heating unit provided on an outer peripheral portion of the cylinder; and a nozzle provided on the cylinder and configured to discharge the material plasticized by rotation of the screw and heating of the first heating unit. The outer peripheral portion has, between the supply port and the nozzle, a first region and a second region from the supply port toward the nozzle, and the first heating unit is provided to make a temperature of the second region higher than a temperature of the first region.

### BRIEF DESCRIPTION OF THE DRAWINGS

FIG. 1 is a diagram showing a schematic configuration of a three-dimensional shaping device according to a first embodiment.

FIG. 2 is a perspective view showing a configuration of a groove portion of a screw according to the first embodiment.

FIG. 3 is a diagram showing a configuration of a first heating unit according to the first embodiment.

FIG. 4 is a diagram showing a configuration of a refrigerant pipe according to the first embodiment.

FIG. 5 is a diagram showing dimensions of respective parts of a shaping unit according to the first embodiment.

FIG. 6 is a flowchart showing contents of a shaping processing according to the first embodiment.

FIG. 7 is a diagram schematically showing a state where a three-dimensional shaped object is shaped.

### DESCRIPTION OF EXEMPLARY EMBODIMENTS

### A. First Embodiment

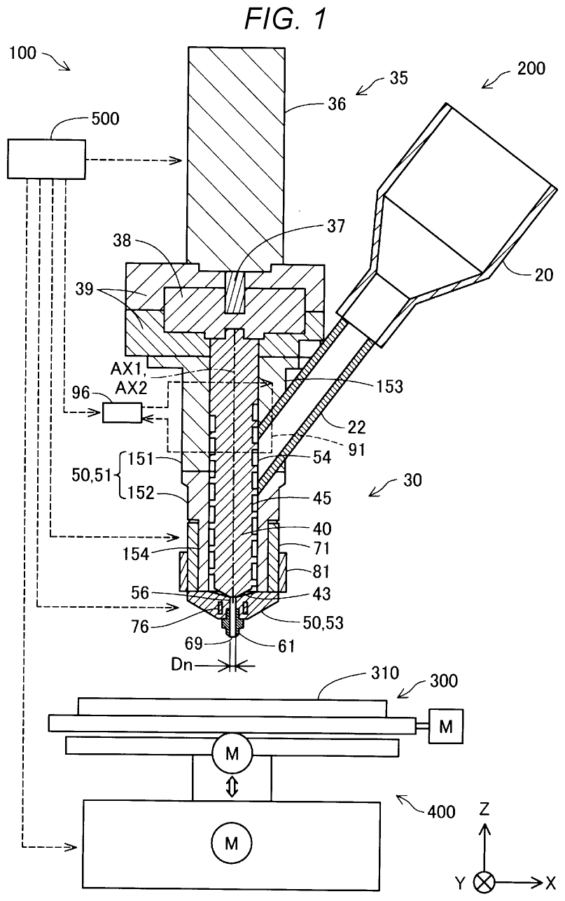

FIG. 1 is a diagram showing a schematic configuration of a three-dimensional shaping device 100 according to a first embodiment. FIG. 1 shows arrows along X, Y, and Z directions orthogonal to each other. The X direction and the Y direction are directions along a horizontal direction, and the Z direction is a direction along a vertical direction. In other figures, the arrows along the X, Y, and Z directions are appropriately shown. The X, Y, Z directions in FIG. 1 and the X, Y, Z directions in other figures represent the same direction.

The three-dimensional shaping device 100 according to the present embodiment includes a shaping unit 200, a stage 300, a moving mechanism 400, and a control unit 500. Under control of the control unit 500, the three-dimensional shaping device 100 shapes a three-dimensional shaped object in which layers of a shaping material are stacked on a shaping surface 310 by driving the moving mechanism 400 to change a relative position between a nozzle hole 69 and the shaping surface 310 while discharging the shaping material from the nozzle hole 69 provided in the shaping unit 200 toward the shaping surface 310 of the stage 300. The shaping material is sometimes referred to as a molten material. A detailed configuration of the shaping unit 200 will be described later.

The moving mechanism 400 changes the relative position between the nozzle hole 69 and the shaping surface 310 as described above. In the present embodiment, the moving mechanism. 400 supports the stage 300, and changes the relative position between the nozzle hole 69 and the shaping surface 310 by moving the stage 300 with respect to the shaping unit 200. The moving mechanism 400 according to the present embodiment is implemented by a three-axis positioner that moves the stage 300 in three axial directions of the X, Y, and Z directions by drive forces of three motors. Each motor is driven under the control of the control unit 500. The moving mechanism 400 may be configured to change the relative position between the nozzle hole 69 and the shaping surface 310 by, instead of moving the stage 300, moving the shaping unit 200 without moving the stage 300. In addition, the moving mechanism 400 may be configured to change the relative position between the nozzle hole 69 and the shaping surface 310 by moving both the stage 300 and the shaping unit 200.

The control unit 500 is implemented by a computer including one or more processors, a main storage device, and an input and output interface for inputting and outputting signals to and from the outside. In the present embodiment, the control unit 500 controls operations of the shaping unit 200 and the moving mechanism 400 by the processor executing a program or a command read in the main storage device, so as to execute a shaping processing for shaping a three-dimensional shaped object. The operations include changing a three-dimensional relative position between the shaping unit 200 and the stage 300. The control unit 500 may be implemented by a combination of a plurality of circuits instead of the computer.

The shaping unit 200 includes a material supply unit 20 that is a material supply source and a plasticization unit 30 that plasticizes a material supplied from the material supply unit 20 to form a shaping material so as to discharge the shaping material from the nozzle hole 69. The term “plasticize” means that a material having thermoplasticity is heated and melted. The term “melt” not only means that the material having thermoplasticity is heated to a temperature equal to or higher than a melting point to become a liquid, but also means that the material having thermoplasticity is softened by being heated to a temperature equal to or higher than a glass transition point to exhibit fluidity. The plasticization unit 30 may also be referred to as a plasticization device.

A material in a state of pellets, powder, or the like is accommodated in the material supply unit 20. In the present embodiment, a pellet-shaped ABS resin is used as the material. The material formed into a pellet has a columnar shape with a diameter of 2.0 mm and a height of 3.0 mm. The material supply unit 20 according to the present embodiment is implemented by a hopper. Below the material supply unit 20, a supply pipe 22 is provided for coupling the material supply unit 20 and the plasticization unit 30. The material supply unit 20 supplies the material to the plasticization unit 30 via the supply pipe 22. In the present embodiment, the material supply unit 20 and the supply pipe 22 each have a cylindrical shape. The material supply unit 20 and the supply pipe 22 are formed of an aluminum alloy. At least one of the material supply unit 20 and the supply pipe 22 is not formed of an aluminum alloy, but may be formed of another metal material such as stainless steel, or may be formed of a resin material or a ceramic material. The material supply unit 20 and the supply pipe 22 may be formed of different materials.

The plasticization unit 30 includes a cylinder 50 having a supply port 54 through which a material is supplied from the material supply unit 20, a screw 40 configured to rotate inside the cylinder 50, a screw drive unit 35 configured to rotate the screw 40, a first heating unit 71 configured to heat the material supplied into the cylinder 50, and a nozzle 61 having the nozzle hole 69 configured to discharge the shaping material. In the present embodiment, the screw drive unit 35, the cylinder 50, and the nozzle 61 are disposed in this order from an upper side to a lower side. The plasticization unit 30 melts at least a part of a solid-state material supplied from the material supply unit 20 by the rotation of the screw 40 and the heating of the first heating unit 71 to convert the material into a paste-shaped shaping material having fluidity, so as to discharge the material from the nozzle hole 69.

The cylinder 50 includes a main body portion 51 and a nozzle fixing portion 53 provided at a lower end of the main body portion 51. The main body portion 51 has a cylindrical shape centered on a central axis AX1. The main body portion 51 is disposed such that the central axis AX1 is along the Z direction. The main body portion 51 includes a first portion 151 and a second portion 152 in this order from an upper end. An outer peripheral side surface of the first portion 151 is referred to as a first outer peripheral portion 153, and an outer peripheral side surface of the second portion 152 is referred to as a second outer peripheral portion 154. The first outer peripheral portion 153 is provided with the supply port 54 through which the material is supplied. The supply pipe 22 is coupled to the supply port 54. An upper end of the first portion 151 is formed in a flange shape. The screw drive unit 35 is fixed to the upper end of the first portion 151. The first heating unit 71 to be described later is provided on the second outer peripheral portion 154. The nozzle fixing portion 53 is fixed to a lower end of the second portion 152. The nozzle fixing portion 53 has a disc shape. A through hole 56 penetrating the nozzle fixing portion 53 along the Z direction is provided at a center of the nozzle fixing portion 53. The nozzle 61 is coupled to a lower end of the through hole 56.

In the present embodiment, the first portion 151, the second portion 152, and the nozzle fixing portion 53 are each formed of stainless steel. In the present embodiment, the first portion 151 and the second portion 152 are integrally formed. For example, the first portion 151 and the second portion 152 can be integrally formed by bonding the first portion 151 and the second portion 152 using a metal bonding technique such as diffusion bonding or hot isostatic press (HIP). The first portion 151 and the second portion 152 may be integrally formed using a three-dimensional shaping technique. The first portion 151 and the second portion 152 may be formed separately. For example, a lower end of the first portion 151 and an upper end of the second portion 152 may each have a flange shape, and the lower end of the first portion 151 and the upper end of the second portion 152 may be fastened by bolts. At least one of the first portion 151 and the second portion 152 is not formed of stainless steel, but may be formed of another metal material such as a titanium alloy, or may be formed of a resin material or a ceramic material. The first portion 151 and the second portion 152 may be formed of different metal materials.

The screw 40 is accommodated in the cylinder 50. More specifically, the screw 40 is accommodated in a space surrounded by the main body portion 51 of the cylinder 50, the nozzle fixing portion 53 of the cylinder 50, and a gear case 39 of the screw drive unit 35 to be described later. The screw 40 has a shaft shape centered on a central axis AX2. The screw 40 is disposed such that the central axis AX2 thereof is along the central axis AX1 of the main body portion 51 of the cylinder 50. An upper end of the screw 40 is coupled to the screw drive unit 35. A tip end portion 43 of the screw 40 is positioned in a vicinity of the through hole 56. Spiral groove portions 45 centered on the central axis AX2 are provided on side surface portions of the screw 40. The groove portions 45 are continuously provided from a portion positioned above the supply port 54 in the screw 40 to the tip end portion 43 of the screw 40. In the present embodiment, the screw 40 is formed of stainless steel subjected to a quenching treatment. The screw 40 is not formed of the stainless steel subjected to the quenching treatment, but may be formed of another metal material such as a titanium alloy, or may be formed of a resin material or a ceramic material. A specific configuration of the groove portion 45 of the screw 40 will be described later.

The screw drive unit 35 includes a drive motor 36, a speed reducer 38, and the gear case 39. The speed reducer 38 is accommodated inside the gear case 39. The gear case 39 is fixed to the upper end of the first portion 151 of the cylinder 50. The drive motor 36 is fixed to an upper surface of the gear case 39. In the present embodiment, a servomotor is used as the drive motor 36. In the present embodiment, the speed reducer 38 is implemented by a gear or the like. The drive motor 36 is driven under the control of the control unit 500. A rotation shaft 37 of the drive motor 36 is coupled to an upper end portion of the screw 40 via the speed reducer 38. Due to torque applied from the drive motor 36 via the speed reducer 38, the screw 40 rotates centered on the central axis AX2 inside the cylinder 50. For example, a stepping motor may be used as the drive motor 36. The speed reducer 38 may be implemented by a pulley, a belt, or the like. The screw drive unit 35 may not include the speed reducer 38 and the gear case 39, and the rotation shaft 37 of the drive motor 36 may be coupled to the upper end portion of the screw 40.

The first heating unit 71 is provided on the second outer peripheral portion 154 positioned between the supply port 54 and the nozzle 61. The phrase “provided on the second outer peripheral portion 154” means to include both being provided along an outer peripheral surface of the second outer peripheral portion 154 and being embedded in the second outer peripheral portion 154. In the present embodiment, the first heating unit 71 is provided along the outer peripheral surface of the second outer peripheral portion 154. A temperature of the first heating unit 71 is controlled by the control unit 500. For example, a temperature sensor may be provided in the first heating unit 71, and the control unit 500 may control the temperature of the first heating unit 71 using the temperature acquired by the temperature sensor. A detailed configuration of the first heating unit 71 will be described later.

In the present embodiment, a heat insulating portion 81 is provided on the first heating unit 71 and on a side opposite to the screw 40. The heat insulating portion 81 is provided so as to cover at least a part of the first heating unit 71. As a material of the heat insulating portion 81, for example, glass wool or ceramic fiber can be used.

In the present embodiment, a second heating unit 76 configured to heat the nozzle 61 is embedded in the nozzle fixing portion 53. A temperature of the second heating unit 76 is controlled by the control unit 500. For example, a temperature sensor may be provided in the second heating unit 76, and the control unit 500 may control the temperature of the second heating unit 76 using the temperature acquired by the temperature sensor.

In the present embodiment, the cylinder 50 is provided with a refrigerant flow path 91 through which a refrigerant flows. The refrigerant flow path 91 is provided inside the first portion 151 along a three-dimensional path passing a vicinity of the supply port 54. The refrigerant flow path 91 is formed by providing a hole having a three-dimensional path in the first portion 151. For example, the first portion 151 provided with the hole having the three-dimensional path can be manufactured using a three-dimensional shaping technique. Both ends of the refrigerant flow path 91 are coupled to the refrigerant supply unit 96 via pipes or the like. The refrigerant supply unit 96 is implemented by a chiller that circulates the refrigerant into the refrigerant flow path 91 and removes heat of the refrigerant flowing through the refrigerant flow path 91. The refrigerant supply unit 96 is driven under the control of the control unit 500. In the present embodiment, water is used as the refrigerant. A detailed configuration of the refrigerant flow path 91 will be described later. As the refrigerant, for example, oil or air may be used instead of water. Instead of both ends of the refrigerant flow path 91, only one end of the refrigerant flow path 91 may be coupled to the refrigerant supply unit 96. In this case, for example, the refrigerant may be discharged to the outside from the other end of the refrigerant flow path 91. The refrigerant flow path 91 is sometimes referred to as a cooling unit.

The nozzle 61 is provided on a lower surface of the nozzle fixing portion 53 of the cylinder 50. The nozzle hole 69 is provided in a tip end portion of the nozzle 61. The nozzle hole 69 communicates with the through hole 56 of the nozzle fixing portion 53. The shaping material flowing from the through hole 56 into an internal flow path of the nozzle 61 is discharged from the nozzle hole 69. In the present embodiment, an opening shape of the nozzle hole 69 is a circle. A diameter of an opening portion of the nozzle hole 69 is referred to as a nozzle diameter Dn. In the present embodiment, the nozzle diameter Dn is set to 0.5 mm. The nozzle diameter Dn is preferably set to be larger than 0.2 mm. The opening shape of the nozzle hole 69 is not limited to a circle, and may be a square or the like. When the opening shape of the nozzle hole 69 is a square, a length of one side of the square is referred to as the nozzle diameter Dn. The opening shape of the nozzle hole 69 may be a polygon other than the square.

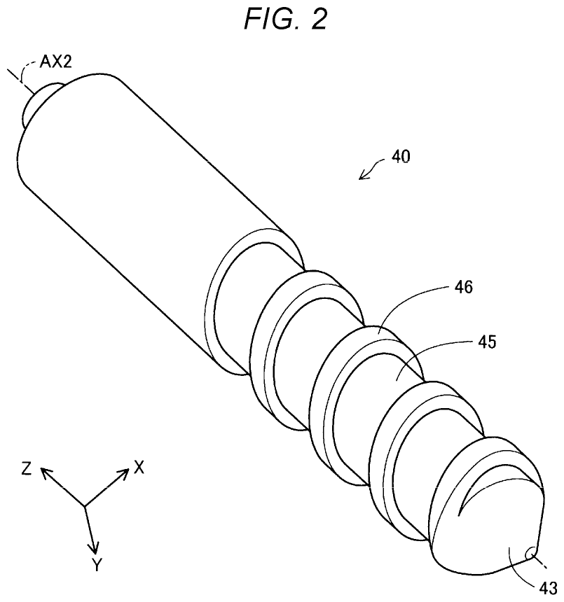

FIG. 2 is a perspective view showing a configuration of the groove portion 45 of the screw 40 according to the present embodiment. In FIG. 2, the central axis AX2 of the flat screw 40 is shown by a dashed line. The spiral groove portions 45 centered on the central axis AX2 are provided on the side surface portions of the screw 40. The groove portions 45 are continuously provided to the tip end portion 43 of the screw 40. Spiral flight portions 46 for separating the groove portions 45 are provided between the groove portions 45. A plurality of groove portions 45 may be provided on the side surface portions of the screw 40. For example, two groove portions 45 may be provided on the side surface portions of the screw 40 in a double spiral shape.

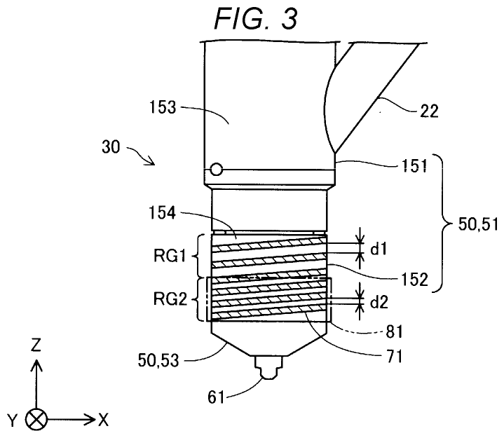

FIG. 3 is a diagram showing a configuration of the first heating unit 71 according to the present embodiment. In FIG. 3, the first heating unit 71 is hatched. In FIG. 3, the heat insulating portion 81 is shown by a two-dot chain line. The cylinder 50 has a first region RG1 and a second region RG2 in the second outer peripheral portion 154. In a direction from the supply port 54 toward the nozzle 61, the first region RG1 and the second region RG2 are disposed in this order. The first heating unit 71 is provided to make a temperature of the second region RG2 higher than a temperature of the first region RG1. In the present embodiment, the first heating unit 71 is implemented by one heater spirally provided over the first region RG1 and the second region RG2. An interval d1 between spirals of the heater in the first region RG1 is set to be wider than an interval d2 between spirals of the heater in the second region RG2. That is, the heater constituting the first heating unit 71 is disposed more densely in the second region RG2 than in the first region RG1. The heat insulating portion 81 is provided so as to cover an outer periphery of a portion of the first heating unit 71 provided in the second region RG2. The first heating unit 71 may be implemented by a plurality of spiral heaters. For example, the first heating unit 71 may be implemented by two heaters having different spiral intervals, and a heater having a wider spiral interval of the two heaters may be disposed in the first region RG1, and a heater having a narrower spiral interval of the two heaters may be disposed in the second region RG2. The first heating unit 71 may not be implemented by a spiral heater. For example, the first heating unit 71 may be implemented by a plurality of rectangular heaters, and an interval between the heaters in the second region RG2 may be narrower than an interval between the heaters in the first region RG1. The heat insulating portion 81 may be provided so as to cover the entire first heating unit 71.

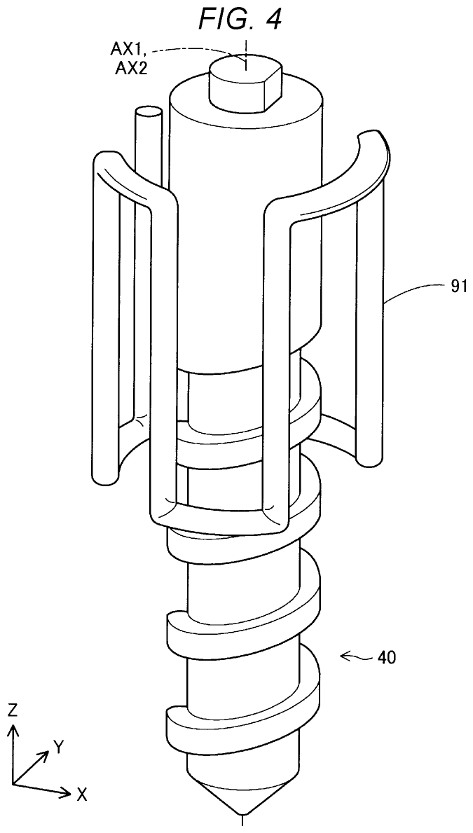

FIG. 4 is a diagram showing a configuration of the refrigerant flow path 91 according to the present embodiment. In FIG. 4, the screw 40 is shown together with the refrigerant flow path 91. In FIG. 4, an illustration of an outer shape of the cylinder 50 is omitted, and an inner wall surface of the cylinder 50 where the refrigerant flow path 91 is formed is shown. In the present embodiment, one refrigerant flow path 91 is three-dimensionally disposed in the first portion 151 of the cylinder 50. The refrigerant flow path 91 is three-dimensionally disposed by coupling portions extending in the Z direction and portions extending along a circumferential direction of a circle centered on the central axis AX1. The refrigerant flow path 91 is disposed evenly over an entire circumference of the first portion 151. The refrigerant flow path 91 may be densely disposed in the vicinity of the supply port 54 in the first portion 151. The refrigerant flow path 91 may be densely disposed in the vicinity of the second portion 152 in the first portion 151. The refrigerant flow path 91 may branch inside the first portion 151. A plurality of refrigerant flow paths 91 may be provided inside the first portion 151. The refrigerant flow path 91 may extend to the second portion 152.

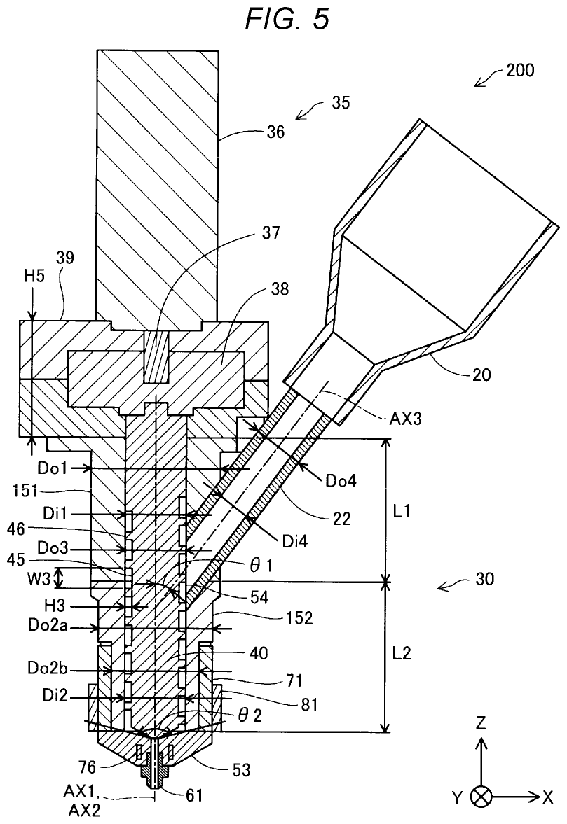

FIG. 5 is a diagram showing dimensions of respective parts of the shaping unit 200 according to the present embodiment. In the present embodiment, an outer diameter Do1 of the first portion 151 of the cylinder 50 is set to 43.0 mm. An inner diameter Di1 of the first portion 151 is set to 20.0 mm. A length L1 of the first portion 151 along the central axis AX1 is set to 50.0 mm. An outer diameter Do2a of a portion of the second portion 152 not provided with the first heating unit 71 is set to 39.0 mm. An outer diameter Do2b of a portion of the second portion 152 provided with the first heating unit 71 is set to 30.0 mm. An inner diameter Di2 of the second portion 152 is set to 20.0 mm. A length L2 of the second portion 152 along the central axis AX1 is set to 50.0 mm.

In the present embodiment, a diameter Do3 of the screw 40 is set to 20.0 mm. The diameter Do3 of the screw 40 means a diameter of the flight portion 46. In the present embodiment, since the diameter Do3 of the screw 40 and the inner diameter Di2 of the second portion 152 of the cylinder 50 are set constant, an interval between an inner wall surface of the second portion 152 and the screw 40 in the first region RG1 is set to be the same as an interval between the inner wall surface of the second portion 152 and the screw 40 in the second region RG2. The interval between the inner wall surface of the second portion 152 and the screw 40 in the first region RG1 and the interval between the inner wall surface of the second portion 152 and the screw 40 in the second region RG2 are each set to 0.1 mm or less. In the present embodiment, a depth H3 of the groove portion 45 is set to 2.5 mm. A width W3 of the groove portion 45 is set to 11.0 mm.

An outer diameter Do4 of the supply pipe 22 is set to 18.0 mm. An inner diameter Di4 of the supply pipe 22 is set to 16.0 mm. An angle θ1 between a central axis AX3 of the supply pipe 22 and the central axis AX1 of the main body portion 51 of the cylinder 50 is set to 35.0°. An upper surface of the nozzle fixing portion 53 is recessed in a mortar shape centered on the through hole 56, and in a cross section passing through the central axis AX1, an angle 82 between facing inclined surfaces in the portion recessed in the mortar shape is set to 140.0°. A height H5 of the gear case 39 of the screw drive unit 35 is set to 42.0 mm.

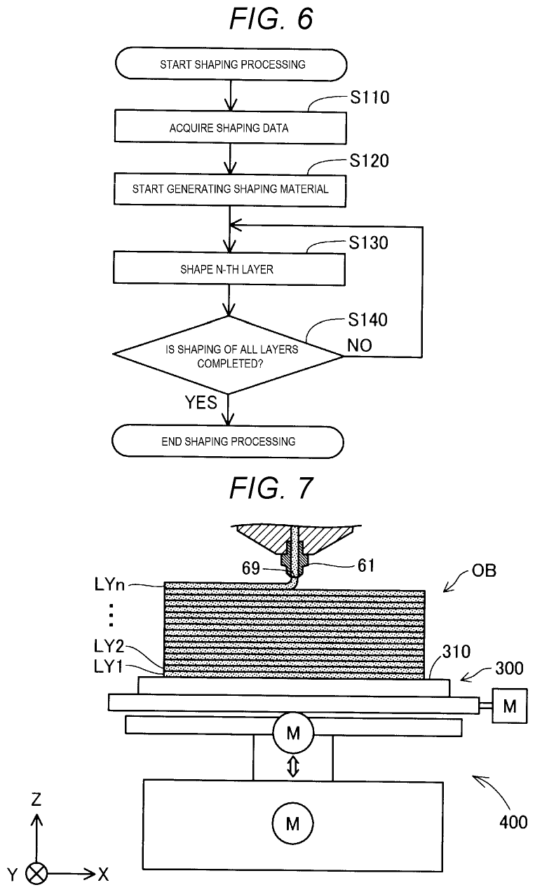

FIG. 6 is a flowchart showing contents of a shaping processing according to the present embodiment. When a predetermined start operation is performed by a user on an operation panel provided in the three-dimensional shaping device 100 or a computer coupled to the three-dimensional shaping device 100, the shaping processing is executed by the control unit 500.

First, in step S110, the control unit 500 acquires shaping data for shaping a three-dimensional shaped object OB. The shaping data represents information about a movement path of the nozzle hole 69 with respect to the stage 300, an amount of the shaping material discharged from the nozzle hole 69, a target rotation speed of the drive motor 36 for rotating the screw 40, a target temperature of a heater in the first heating unit 71, or the like. The shaping data is generated by, for example, slicer software installed in the computer coupled to the three-dimensional shaping device 100. The slicer software reads shape data showing a shape of the three-dimensional shaped object OB created using three-dimensional CAD software or three-dimensional CG software, and divides the shape of the three-dimensional shaped object OB into layers with a predetermined thickness, so as to generate the shaping data. Data in an STL format or an AMF format can be used for the shape data read into the slicer software. The shaping data created by the slicer software is shown with a G code, an M code, or the like. The control unit 500 acquires the shaping data from the computer coupled to the three-dimensional shaping device 100 or a recording medium such as a USB memory.

Next, in step S120, the control unit 500 starts generating the shaping material. The control unit 500 controls the rotation of the screw 40 and the temperature of the heater in the first heating unit 71 to melt the material so as to generate the shaping material. By the rotation of the screw 40, the material supplied from the supply port 54 into the cylinder 50 is introduced into the groove portion 45 of the screw 40. The material introduced into the groove portion 45 is conveyed along the groove portion 45 from the supply port 54 toward the through hole 56. While the material is being conveyed along the groove portion 45, at least a part of the material is melted by a relative rotation between the screw 40 and the cylinder 50 and the heating of the first heating unit 71 to become a paste-shaped shaping material having fluidity. The higher the temperature of the first heating unit 71, the more easily the material is melted. The larger a rotation speed of the screw 40, the more easily the material is melted. The larger the rotation speed of the screw 40, the more easily the material is to be conveyed toward the nozzle 61. The shaping material collected in a vicinity of the tip end portion 43 of the screw 40 is supplied to the nozzle 61 via the through hole 56 by an internal pressure. The shaping material continues to be generated while the processing is performed.

FIG. 7 is a diagram schematically showing a state where the three-dimensional shaped object OB is shaped. Referring to FIGS. 6 and 7, and in step S130, the control unit 500 shapes a first layer LY1 of the three-dimensional shaped object OB according to the shaping data. The nozzle fixing portion 53 may be provided with a pressure sensor for measuring a pressure of the shaping material inside the through hole 56. In step S130, the control unit 500 may adjust the rotation speed of the screw 40 by controlling the drive motor 36 according to a value of the pressure measured by the pressure sensor. The nozzle fixing portion 53 may be provided with a flow rate sensor for measuring a flow rate of the shaping material inside the through hole 56. In step S130, the control unit 500 may adjust the rotation speed of the screw 40 by controlling the drive motor 36 according to a value of the flow rate measured by the flow rate sensor.

After the formation of the first layer LY1 is completed, in step S140, the control unit 500 determines whether the shaping of all layers of the three-dimensional shaped object OB is completed. The control unit 500 can determine, using the shaping data, whether the shaping of all layers of the three-dimensional shaped object OB is completed. When it is determined in step S140 that the shaping of all layers of the three-dimensional shaped object OB is completed, the control unit 500 ends the processing. On the other hand, when it is determined in step S140 that the shaping of all layers of the three-dimensional shaped object OB is not completed, the control unit 500 returns the processing to step S130 to shape a second layer LY2 of the three-dimensional shaped object OB. The control unit 500 repeats the processing from step S130 to step S140 until it is determined in step S140 that the shaping of all layers of the three-dimensional shaped object OB is completed, so as to shape the three-dimensional shaped object OB in which a plurality of layers are stacked. After the shaping processing, a cutting process may be applied to the three-dimensional shaped object OB.

According to the three-dimensional shaping device 100 of the present embodiment described above, since the first heating unit 71 is provided to make the temperature of the second region RG2 higher than the temperature of the first region RG1 of the cylinder 50, a temperature of the cylinder 50 can be set to increase from the supply port 54 toward the nozzle 61. Therefore, it is possible to sufficiently melt a material in the vicinity of the nozzle 61 while preventing material conveyance due to the rotation of the screw 40 from becoming difficult due to the material being melted in the vicinity of the supply port 54. Since it is possible to prevent the material conveyance due to the rotation of the screw 40 from becoming difficult, it is possible to prevent an insufficiency of an amount of the material discharged from the nozzle hole 69.

In the present embodiment, the first heating unit 71 is implemented by a heater spirally provided over the first region RG1 and the second region RG2, and the interval d1 between spirals of the heater in the first region RG1 is set to be wider than the interval d2 between spirals of the heater in the second region RG2. Therefore, the temperature of the second region RG2 can be higher than the temperature of the first region RG1.

In the present embodiment, since the heat insulating portion 81 is provided so as to cover the outer periphery of the first heating unit 71, it is possible to prevent the heat generated by the first heating unit 71 from diffusing to the outside. Therefore, the heat of the first heating unit 71 can be easily transferred to the cylinder 50. In particular, a material having a high melting point such as polyetheretherketone (PEEK) can be easily melted.

In the present embodiment, since the second heating unit 76 for heating the nozzle 61 is embedded in the nozzle fixing portion 53, a temperature of the material in the vicinity of the nozzle 61 can be increased. Therefore, fluidity of the material discharged from the nozzle hole 69 can be increased.

In the present embodiment, the refrigerant flow path 91 through which the refrigerant flows is provided in the first portion 151 having the supply port 54, and the first heating unit 71 is provided in the second portion 152. Therefore, it is possible to further prevent the temperature in the vicinity of the supply port 54 from becoming too high.

In the present embodiment, a pellet-shaped ABS resin is used as the material, whereas as a material used in the shaping unit 200, for example, a material for shaping a three-dimensional shaped object using various materials such as a material having thermoplasticity, a metal material, and a ceramic material as a main material can also be used. Here, the “main material” means a central material for forming a shape of the three-dimensional shaped object, and a material occupying a content of 50% by weight or more in the three-dimensional shaped object. The above shaping materials include those in which main materials are melted alone, and those in which some of the components contained together with the main materials are melted to form a paste.

When the material having thermoplasticity is used as the main material, a shaping material is generated by plasticizing the material in the plasticization unit 30. The term “plasticize” means that the material having thermoplasticity is heated and melted. The term “melt” not only means that the material having thermoplasticity is heated to a temperature equal to or higher than a melting point to become a liquid, but also means that the material having thermoplasticity is softened by being heated to a temperature equal to or higher than a glass transition point to exhibit fluidity.

As the material having thermoplasticity, for example, a thermoplastic resin material obtained by combining one or more of the following can be used.

### Example of Thermoplastic Resin Material

General-purpose engineering plastics such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyetheretherketone (PEEK)

The material having thermoplasticity may contain an additive such as a pigment, a metal, a ceramic, a wax, a flame retardant, an antioxidant, and a heat stabilizer. The material having thermoplasticity is plasticized by the rotation of the screw 40 and the heating of the first heating unit 71 and is then converted into a melted state in the plasticization unit 30. After the shaping material thus generated is discharged from the nozzle hole 69, the shaping material is cured due to a reduction in temperature.

It is desirable that the material having thermoplasticity is discharged from the nozzle holes 69 in a state where the material is heated to a temperature equal to or higher than the glass transition point thereof and is in a completely melted state. The term “completely melted state” means a state where a non-melted material having thermoplasticity does not exist, and means a state where, for example, when a pellet-shaped thermoplastic resin is used as the material, a pellet-shaped solid does not remain.

In the shaping unit 200, for example, the following metal material may be used as a main material instead of the above material having thermoplasticity. In this case, it is desirable that a component to be melted at the time of generating the shaping material is mixed with a powder material obtained by converting the following metal material into powder, and then the mixture is charged into the plasticization unit 30.

### Example of Metal Material

A single metal of magnesium (Mg), iron (Fe), cobalt (Co) or chromium (Cr), aluminum (Al), titanium (Ti), copper (Cu), and nickel (Ni), or an alloy containing one or more of these metals

### Example of Alloy

Maraging steel, steel, stainless steel, cobalt chrome molybdenum, titanium alloy, nickel alloy, aluminum alloy, cobalt alloy, and cobalt chromium alloy

In the shaping unit 200, a ceramic material can be used as a main material instead of the above metal material. As the ceramic material, for example, oxide ceramics such as silicon dioxide, titanium dioxide, aluminum oxide, and zirconium oxide, and non-oxide ceramics such as aluminum nitride can be used. When the above metal material or ceramic material is used as the main material, the shaping material disposed on the stage 300 may be cured by, for example, sintering with laser irradiation or warm air.

The powder material of the metal material or the ceramic material charged into the material supply unit 20 may be a mixed material obtained by mixing a plurality of types of powder including single metal powder, alloy powder, and ceramic material powder. The powder material of the metal material or the ceramic material may be coated with, for example, the thermoplastic resin shown above or another thermoplastic resin. In this case, the thermoplastic resin may be melted in the plasticization unit 30 to exhibit fluidity.

For example, the following solvents can be added to the powder material of the metal material or the ceramic material charged into the material supply unit 20. The solvent can be used alone or in combination of two or more selected from the following.

### Example of Solvent

Water, (poly)alkylene glycol monoalkyl ethers such as ethylene glycol monomethyl ether, ethylene glycol monoethyl ether, propylene glycol monomethyl ether, and propylene glycol monoethyl ether, acetate esters such as ethyl acetate, n-propyl acetate, iso-propyl acetate, n-butyl acetate, and iso-butyl acetate, aromatic hydrocarbons such as benzene, toluene, and xylene, ketones such as methyl ethyl ketone, acetone, methyl isobutyl ketone, ethyl-n-butyl ketone, diisopropyl ketone, and acetylacetone, alcohols such as ethanol, propanol, and solvents such as dimethyl sulfoxide and diethyl sulfoxide, pyridine-based solvents such as pyridine, γ-picoline, and 2,6-lutidine, tetraalkylammonium acetates (such as tetrabutylammonium acetate), and ionic liquids such as butyl carbitol acetate

In addition, for example, the following binders can be added to the powder material of the metal material or the ceramic material charged into the material supply unit 20.

### Example of Binder

Acrylic resin, epoxy resin, silicone resin, cellulose resin or other synthetic resins, or polylactic acid (PLA), polyamide (PA), polyphenylene sulfide (PPS), polyetheretherketone (PEEK) or other thermoplastic resins

### B. Other Embodiments

(B1) In the three-dimensional shaping device 100 according to the embodiment described above, the heater constituting the first heating unit 71 is densely disposed in the second region RG2 than in the first region RG1. In contrast, the heater constituting the first heating unit 71 may be evenly disposed in the first region RG1 and in the second region RG2. In this case, for example, the first heating unit 71 may be implemented by a plurality of heaters disposed at equal intervals in the first region RG1 and the second region RG2, and the control unit 500 may control a temperature of each heater to make the temperature of the second region RG2 higher than the temperature of the first region RG1.

(B2) In the three-dimensional shaping device 100 of the embodiment described above, the heat insulating portion 81 is provided on the first heating unit 71 and on the side opposite to the screw 40. In contrast, the heat insulating portion 81 may not be provided on the first heating unit 71 and on the side opposite to the screw 40. Even in this case, the first heating unit 71 can make the temperature of the second region RG2 higher than the temperature of the first region RG1.

(B3) In the three-dimensional shaping device 100 of the embodiment described above, the second heating unit 76 is provided in the nozzle fixing portion 53. In contrast, the second heating unit 76 may not be provided in the nozzle fixing portion 53.

(B4) In the three-dimensional shaping device 100 of the embodiment described above, the refrigerant flow path 91 is provided inside the first portion 151 of the cylinder 50. In contrast, the refrigerant flow path 91 may not be provided inside the first portion 151.

(B5) In the three-dimensional shaping device 100 of the embodiment described above, an interval between the inner wall surface of the cylinder 50 and the screw 40 in the first region RG1 is set to be the same as an interval between the inner wall surface of the cylinder 50 and the screw 40 in the second region RG2. In contrast, the interval between the inner wall surface of the cylinder 50 and the screw 40 in the second region RG2 may be set wider than the interval between the inner wall surface of the cylinder 50 and the screw 40 in the first region RG1. In this case, since the heat is less likely to be transferred from the second region RG2 of the cylinder 50 to the screw 40, it is possible to prevent the heat from being transferred to the material in the vicinity of the supply port 54 via the screw 40. For example, by setting an inner diameter of the cylinder 50 in the second region RG2 to be larger than an inner diameter of the cylinder 50 in the first region RG1, the interval between the inner wall surface of the cylinder 50 and the screw 40 in the second region RG2 can be set wider than the interval between the inner wall surface of the cylinder 50 and the screw 40 in the first region RG1. By setting a diameter of the screw 40 in the second region RG2 to be smaller than a diameter of the screw 40 in the first region RG1, the interval between the inner wall surface of the cylinder 50 and the screw 40 in the second region RG2 can be set wider than the interval between the inner wall surface of the cylinder 50 and the screw 40 in the first region RG1. Both the diameter of the screw 40 and the inner diameter of the cylinder 50 may be different in the first region RG1 and the second region RG2 such that the interval between the inner wall surface of the cylinder 50 and the screw 40 in the second region RG2 is wider than the interval between the inner wall surface of the cylinder 50 and the screw 40 in the first region RG1.

(B6) In the three-dimensional shaping device 100 of the embodiment described above, the first portion 151 and the second portion 152 of the cylinder 50 each have a cylindrical shape, and in a cross section perpendicular to the central axis AX1, a shape of an outer contour line of the first portion 151 and a shape of an inner contour line of the first portion 151 are circles, and a shape of an outer contour line of the second portion 152 and a shape of an inner contour line of the second portion 152 are circles. In contrast, in the cross section perpendicular to the central axis AX1, at least one of the shape of the outer contour line of the first portion 151 and the shape of the outer contour line of the second portion 152 may not be a circle. For example, in the cross section perpendicular to the central axis AX1, at least one of the shape of the outer contour line of the first portion 151 and the shape of the outer contour lines of the second portion 152 may be a polygon such as a quadrangle or a hexagon.

### C. Other Aspects

The present disclosure is not limited to the above-described embodiments, and can be implemented in various aspects without departing from the spirit of the present disclosure. For example, the present disclosure can be implemented by the following aspects. In order to solve some or all of the problems described in the present disclosure, or to achieve some or all of the effects of the present disclosure, technical characteristics in the above embodiments corresponding to the technical characteristics in each of the embodiments described below can be appropriately replaced or combined. If the technical characteristics are not described as essential in the present description, they can be deleted as appropriate.

(1) According to one aspect of the present disclosure, a plasticization device used in a three-dimensional shaping device is provided. The plasticization device includes: a cylinder having a supply port through which a material is supplied; a spiral screw configured to rotate inside the cylinder; a first heating unit provided on an outer peripheral portion of the cylinder; and a nozzle provided on the cylinder and configured to discharge the material plasticized by rotation of the screw and heating of the first heating unit. The outer peripheral portion has, between the supply port and the nozzle, a first region and a second region from the supply port toward the nozzle, and the first heating unit is provided to make a temperature of the second region higher than a temperature of the first region.

According to the plasticization device of this aspect, since a temperature of the cylinder can be set to increase from the supply port toward the nozzle, it is possible to prevent material conveyance due to the rotation of the screw from becoming difficult due to the material being melted in a vicinity of the supply port. Therefore, it is possible to prevent an insufficiency of an amount of the material discharged from a tip end of the nozzle.

(2) In the plasticization device of the above aspect, the first heating unit may be provided spirally over the first region and the second region, and an interval between spirals of the first heating unit in the first region may be set to be wider than an interval between spirals of the first heating unit in the second region.

According to the plasticization device of this aspect, the temperature of the second region can be higher than the temperature of the first region.

(3) In the plasticization device of the above aspect, a heat insulating portion may be provided on the first heating unit and on a side opposite to the screw.

According to the plasticization device of the aspect, heat of the first heating unit can be easily transferred to the cylinder.

(4) In the plasticization device of the above aspect, a second heating unit configured to heat the nozzle may be provided.

According to the plasticization device of this aspect, a temperature of a material in a vicinity of the nozzle can be increased. Therefore, fluidity of the material discharged from the nozzle can be increased.

(5) In the plasticization device of the above aspect, the first heating unit and a cooling unit may be provided in the outer peripheral portion from the nozzle toward the supply port.

According to the plasticization device of this aspect, it is possible to prevent a temperature of the material in the vicinity of the supply port from becoming too high.

(6) In the plasticization device of the above aspect, an interval between an inner wall surface of the cylinder and the screw in the second region may be wider than an interval between an inner wall surface of the cylinder and the screw in the first region.

According to the plasticization device of this aspect, since the heat is less likely to be transferred from the first region of the cylinder to the screw, it is possible to prevent the heat from being transferred to the material in the vicinity of the supply port via the screw.

The present disclosure may be implemented in various aspects other than the plasticization device. For example, the present disclosure can be implemented in a form of a three-dimensional shaping device or the like.

What is claimed is:

1. A plasticization device for use in a three-dimensional shaping device, the plasticization device comprising:
a cylinder having a supply port through which a material is supplied;
a spiral screw configured to rotate inside the cylinder;
a first heating unit provided on an outer peripheral portion of the cylinder; and
a nozzle provided on the cylinder and configured to discharge the material plasticized by rotation of the screw and heating of the first heating unit, wherein
the outer peripheral portion has, between the supply port and the nozzle, a first region and a second region from the supply port toward the nozzle, and
the first heating unit is provided to make a temperature of the second region higher than a temperature of the first region.

2. The plasticization device according to claim 1, wherein
the first heating unit is provided spirally over the first region and the second region, and
an interval between spirals of the first heating unit in the first region is set to be wider than an interval between spirals of the first heating unit in the second region.

3. The plasticization device according to claim 1, wherein
a heat insulating portion is provided on the first heating unit and on a side opposite to the screw.

4. The plasticization device according to claim 1, wherein
a second heating unit configured to heat the nozzle is provided.

5. The plasticization device according to claim 1, wherein
the first heating unit and a cooling unit are provided in the outer peripheral portion from the nozzle toward the supply port.

6. The plasticization device according to claim 1, wherein
an interval between an inner wall surface of the cylinder and the screw in the second region is wider than an interval between an inner wall surface of the cylinder and the screw in the first region.

7. A three-dimensional shaping device comprising:
a cylinder having a supply port through which a material is supplied;
a spiral screw configured to rotate inside the cylinder;
a screw drive unit configured to rotate the screw;
a heating unit provided on an outer peripheral portion of the cylinder;
a nozzle provided on the cylinder and configured to discharge the material plasticized by rotation of the screw and heating of the heating unit towards a stage; and
a control unit configured to control the screw drive unit and the heating unit, wherein
the outer peripheral portion has, between the supply port and the nozzle, a first region and a second region from the supply port toward the nozzle, and
the heating unit is provided to make a temperature of the second region higher than a temperature of the first region.
